(19) United States
(12) Patent Application Publication
(10) Pub. No.: US 2013/0226745 A1
(43) Pub. Date: Aug. 29, 2013

(54) METHOD AND SYSTEM FOR ABUSE PATTERN DETECTION

(71) Applicants: Mark Dixon, Woodsboro, MD (US); Mark Golczewski, Forest Hill, MD (US)

(72) Inventors: Mark Dixon, Woodsboro, MD (US); Mark Golczewski, Forest Hill, MD (US)

(73) Assignee: COMMERCIAL FUEL SYSTEMS, INC., Mt. Airy, MD (US)

(21) Appl. No.: 13/840,705

(22) Filed: Mar. 15, 2013

Related U.S. Application Data
(63) Continuation-in-part of application No. 13/594,111, filed on Aug. 24, 2012, now abandoned.
Application No. 13/594,111 is a continuation of application No. 12/367,239, filed on Feb. 6, 2009, now Pat. No. 8,255,294.

(51) Int. Cl. G06Q 10/08

(52) U.S. Cl. CPC G06Q 10/087
USPC 705/28

(57) ABSTRACT

A method and system for detecting a pattern of abuse receives at an input port supply data associated with a corresponding one of the one or more vehicles. Consumption specification data associated with the one or more vehicles are retrieved from a storage device. The consumption specification data is specified by at least one of a vehicle manufacturer or an authority, e.g. a commercial, governmental or military authority. The method and system provides the supply data to a processing unit over a physical transmission medium to determine a pattern of abuse relative to the consumption specification data.

### CROSS REFERENCE TO RELATED APPLICATIONS

This application is a continuation-in-part of co-pending U.S. patent application Ser. No. 13/594,111, filed Aug. 24, 2012, entitled “METHOD AND SYSTEM THAT MONITORS SUPPLY OF PHYSICAL CONSUMABLES RELATIVE TO CONSUMPTION SPECIFICATIONS”, attorney docket no. 99907-337333, which is a continuation application of U.S. Pat. No. 8,255,294, Ser. No. 12/367,239, filed Feb. 6, 2009, entitled “METHOD AND SYSTEM THAT MONITORS SUPPLY OF PHYSICAL CONSUMABLES RELATIVE TO CONSUMPTION SPECIFICATIONS”, attorney docket no. 99907-263603, the contents of each of which is hereby incorporated herein by reference in its entirety.

### FIELD OF THE INVENTION

This invention relates to a supply monitoring system and method, and more particularly, to monitoring supply to determine patterns of abuse in one or more vehicles.

### BACKGROUND OF THE INVENTION

Vehicle health monitoring is becoming increasingly more important in managing vehicle and vehicle fleet health. Vehicle and vehicle fleet health is a growing concern for a variety of reasons. For example, maintaining a vehicle in a proper operating condition may reduce safety issues and the potential for accidents for the vehicle operator, other motorists, and pedestrians. Additionally, maintaining a vehicle in a proper operating condition may reduce costs associated mechanical failures during operation. Avoidable costs may include delays in transporting goods or people, repairing a vehicle at inconvenient places (e.g. roadside), finding a replacement vehicle, using emergency assistance such as towing, etc. Preventing potential mechanical failures in vehicles can eliminate the cost, time, and inconvenience of dealing with the failures when they occur during vehicle operation.

Several systems exist for monitoring vehicle health. For example, Isuzu offers one such vehicle health monitoring system, as described by Isuzu Commercial Vehicles, available at “http://www.isuzucv.com/service/vehiclehealth”, the contents of which are hereby incorporated herein by reference in its entirety. Isuzu's system uses a data recording module feature, in which a dealer can provide a computer health report on a truck's condition, usage, and driving patterns. Isuzu's 2008 and later trucks incorporate a vehicle management tool, in which a Data Recording Module (DRM) monitors a truck's performance in several areas. The system enables Certified Service Center technicians to produce vehicle health reports that show the current status of engine condition, emissions system condition, brake usage history, fuel economy with history, and driver operating habits. Vehicle health reports provide details of major component's current operating status, from which service diagnosis, component failure/wear history, and adherence with maintenance programs may be obtained. Despite being able to provide vehicle component's status, Isuzu's system lacks the ability to take the data and look for a pattern of anomalies. Instead, Isuzu's system looks for abnormal readings, but not as a predictable pattern.

U.S. Pat. No. 4,658,371, issued Apr. 14, 1987 to Walsh et. al., discloses a method to prevent fuel theft and to control maintenance of authorized vehicles through a portable memory unit removably connected to an on-board computer. The on-board computer senses vehicle conditions through transducer carburetor settings. At a fuel dispensing site, a data processing unit receives and stores vehicle condition information relayed through the portable memory unit from the on-board computer. If discrepancies are detected, the operator is notified to immediately take the vehicle to a maintenance facility. However, despite being able to provide fuel usage information, Walsh's system lacks the ability to take the data and look for a pattern of anomalies. Instead, Walsh's system can only identify discrepancies in fuel usage from an amount dispensed to a vehicle—not as a predictable pattern.

With an increasing focus on reducing costs and delays, there is a commensurate need to develop a system and method to monitor and detect patterns of abuse, in order to save vehicle fleet owners from the cost, time, and inconvenience of dealing with the failures when they occur during vehicle operation.

### SUMMARY

Briefly, according to the present invention, a method and system for detecting a pattern of abuse in one or more vehicles receives, at an input port, supply data associated with a corresponding one of the one or more vehicles. In one exemplary embodiment, an on board data system provides supply data for the one or more vehicles. The method and system of the invention retrieves consumption specification data associated with the one or more vehicles from a storage device. The consumption specification data relates to the physical consumables and for example includes specified miles per gallon of fuel consumed for various types of vehicle make or models. The consumption specification data is specified by at least one of a vehicle manufacturer or an authority, e.g., a commercial, governmental or military authority. The method and system of the present invention provides the supply data to a processing unit over a physical transmission medium to determine a pattern of abuse relative to the consumption specification data.
According to some of the more detailed features of the present invention, a pattern of abuse may indicated at least one of a predicted service time, wherein the predicted service time is earlier than an expected service time indicated by the consumption specification data; and an abuse pattern model. An Abuse Pattern Model is a computer generated report based upon a collection of source data from real world operations that is compared to authoritative normal performance specifications for normal operation during the same time frame. The difference between the comparisons is analyzed for anomalies indicating performance outside of the authoritative specifications. The pattern is used to indicate abuse or predict failure. In one embodiment, the method and system of the present invention compares the pattern of abuse to a defined consumption criterion in order to produce a comparison result that may for example be used to detect irregularities in the supply of the physical consumables. In one embodiment, the method and system of the present invention outputs data associated with the comparison result, for example, by displaying information associated with the pattern of abuse or comparison result. Instead of displaying such data, either of the pattern of abuse or comparison result may be placed on another physical transmission medium for further processing. The comparison result may be derived for a relationship between the actual consumption and a reference consumption data. The reference date may correspond to a parameter that allows distinguishing between regular or irregular supply of consumables, which may include vehicle parts, to vehicles. The method and system may further perform a function associated with the comparison result, such as communicating an alert message or signal.

### BRIEF DESCRIPTIONS OF THE DRAWINGS

The present invention will be more readily understood from the following detailed description when read in conjunction with the accompanying drawings, in which:

FIG. 1 is an exemplary block diagram of a system according to the present invention.

FIG. 2 is an exemplary flow diagram of a method for monitoring supply of physical consumables according to the present invention.

FIG. 3 is an exemplary display of data using the system and method of FIGS. 1 and 2.

FIG. 4 is a block diagram of an Abuse Pattern Matching (APM) system that applies the present invention for detecting abuses in a fuel supply system.

### DETAILED DESCRIPTION

The present invention relates to a method and system for processing data associated with a physical consumable for one or more vehicles and comparing the results against a consumption specification. In one exemplary application, the present invention may be used to monitor and detect patterns of abuse.

### Definitions:

The term “physical consumable” comprises a physical matter that is consumed. Exemplary physical consumables include fuel, wood, coal, oil, gasoline, diesel fuel, natural gas, kerosene, jet fuel, petroleum, bunker fuel, electricity, solid-fuel, bio-fuel, nuclear fuel, hydraulic fluid, air, and vehicle parts.

The term “consumption specification data” relates to specified information associated with a physical consumable for a particular vehicle or class of vehicles. For example, the consumption information can be specified by a manufacturer or an authority. Exemplary consumption specification data includes energy consumption data and expected lifetimes of vehicle parts. Exemplary authorities include a commercial entity, a military entity or a governmental entity (local, state or federal). One such authority is the U.S. Department of Energy, which publishes fuel economy specification for vehicles by make, model and year.

The term “fleet” relates to a group or sub-group of one or more vehicles the operations of which are managed by one or more entities, including military, governmental or commercial entities.

The term “fuel” relates to any material that is used to obtain energy.

The term “input port” relates to a physical interface of a computer, network, node or device for the purpose of receiving information.

The term “output port” relates to a physical interface of a computer, network, node or device for the purpose of outputting information for performing a function, for example, displaying information, or for further processing of the information.

The term “physical transmission medium” refers to a wired medium, wireless medium, biological medium or optical medium. Exemplary wired mediums include a physical layer, including a network physical layer or a physical bus structure. Exemplary wireless mediums include those compliant with promulgated standards, for example IEEE 802.1x standards, as well as proprietary wireless standards.

The term “processing unit” comprises a machine, node, device or circuit that manipulates data according to a logic, program, instruction set, etc. Exemplary processing units comprise CPUs, embedded controllers, computers, mainframes, servers, clients, etc.

The term “supply data” relates to information associated with supply of physical consumables, for example supply of fuel to one or more vehicles. Supply data may also be associated with information that identifies vehicles and/or operators, as well as operational information such as odometer readings, date and time of fuel intake, fuel cost, and pressure readings.

The term “vehicle” relates to any physical transport apparatus, buses, vans, trucks, motorcycles, airplanes, helicopters, ships, boats, trains, spacecraft, including those having commercial, military or government applications.

### Method and System Description

Patterns of anomalies within specific systems may indicate abuse or non-intentional abuse as related to insufficient manufactures quality may result in early failure of systems or system components. The ability to scan systems where anomalies are tracked, recorded, and analyzed for patterns can be used to determine abuse as either something that has been caused to happen or the result of insufficient attention. These patterns may then be used to predict an early or unanticipated failure of the system. This type of application would may be of significant use to, for example, mission critical systems and military readiness.

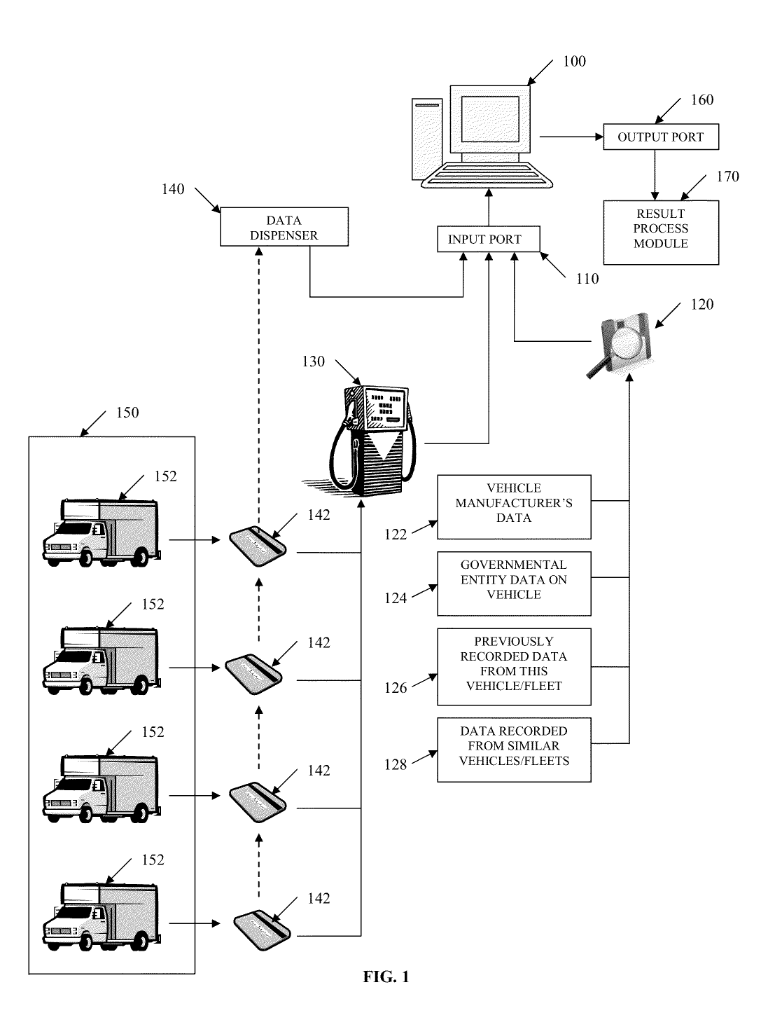

FIG. 1 depicts an exemplary block diagram showing the system components of the present invention. In this exemplary diagram, the vehicle fleet 150 consists of one or more groups or sub-groups of vehicles 152. Each of the vehicles may have an on board data system. An on board data system may measure, record, track, and/or store supply data associated with each vehicle. The operator or user of each vehicle may use an access device 142 to access a supply device 130. The supply device 130 may supplies physical consumables. Exemplary supply device can be a fuel supply, oil supply, gas supply, nuclear supply, bio fuel supply or an electric supply.

An exemplary access device 142 may be any device, e.g., a card, wired device or wireless device, having the capability of storing and/or communicating supply data, such as vehicle identification, user/operator identification, or other operational data, such as time and date, odometer reading, etc. For example, an access card may store a key that allows the supply device 130 to identify and grant fuel supply access to a vehicle. The access device 142 may store information, such as vehicle identity, operator identity and vehicle characteristics. In one embodiment, upon grant of access to an operator of the vehicle, the supply device 130 allows dispensing of the physical consumable. Once the operator finishes with dispensing the physical consumables, the supply device 130 records and/or communicates the amount of dispensed physical consumable for further processing by the processing unit 100, which receives the supply data via the input port 110. Under this arrangement, the supply device 130 records and/or communicates the supply data directly to the processing unit 100 via the input port 110. Or in another embodiment, the supply device 130 records and/or communicates the supply data directly to a device comprising both an input port and a processing unit. Alternatively, the on board data system may record the supply data on the access device 142 itself. In this way, the access device 142 transmits the supply data received from the supply device 130 through a physical transmission medium, for example, a wireless medium, to a data dispenser 140. The data dispenser 140 collects and stores the supply data and access device information and transmits it through physical a transmission medium to the input port 110 of the processing unit 100.

The processing unit 100 retrieves consumption specification data for the vehicle or sub-fleet of vehicles from a storage device 120, which in one exemplary embodiment may comprise one ore more central or distributed databases accessible by the processing unit storing the consumption specification data as well as other access device related data. The consumption specification data may be originated by the vehicle manufacturer or other authority, for example the U.S. Department of Energy. In one embodiment, the storage device 120 provides the consumption specification data in response to a retrieval request from the processing unit 100.

In one exemplary embodiment, the storage device 120 also stores reference consumption data associated with a fleet, sub-fleet, or one or more vehicles as well as groups or sub-groups thereof. The reference consumption data may correspond to data associated with regular consumption of the physical consumables. Such reference consumption data may be used to detect any irregularities in the supply of physical consumables. In another exemplary embodiment, the storage device 120 runs periodic updates to provide the most current and up-to-date consumption specification data and reference consumption data available.

In a further exemplary embodiment, the storage device 120 catalogs the information by vehicle make and model to facilitate efficient retrieval by the processing unit 100. Using this exemplary method, the processing unit 100 may retrieve a specific category of information for a particular vehicle make and model without running an extensive database search.

The processing unit 100 then processes the supply data to determine a pattern of abuse relative to the consumption specification data. In one embodiment, the processing involves a comparator logic that compares the pattern of abuse to a reference consumption criterion to produce a comparison result. The reference consumption criteria may be based on the reference consumption data in a way that allows for detection of supply patterns to the one or more vehicles. The result process module 170 is an analysis module that analyzes the data pulled by processing unit 100. The output of the result process module 170 may then be sent to an output port 160 in the form of reports or alerts. The result processing module 170 processes the comparison result according to a specified logic for performing a function, e.g., displaying the pattern of abuse data or sending an alert message. In a further embodiment, data may be fed into additional analysis modules.

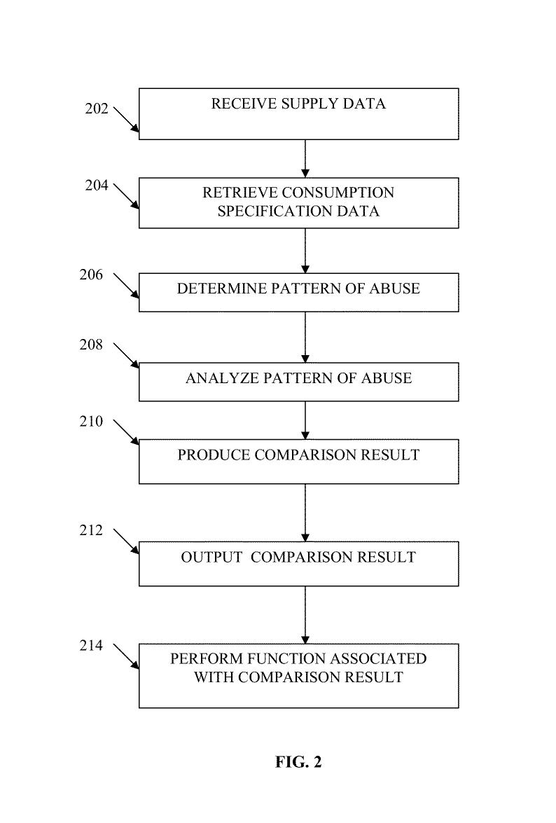

FIG. 2 depicts an exemplary flow diagram of a method for monitoring the supply of physical consumables to one or more vehicles. A processing unit receives through an input port supply data originated at a supply device, block 202. The processing unit then retrieves consumption specification data, for example, from a storage device, block 204. The supply data and consumption specification data are processed to determine a pattern of abuse of the supply data relative to the retrieved consumption specification data, block 206. The processing unit then analyzes the pattern of abuse 208 in order to produce a comparison result, block 208 and 210. Based on the comparison result, the processing unit outputs the comparison result, block 212, for performing a function associated with the comparison result, block 214.

In an exemplary embodiment, the processing unit analyzes the pattern of abuse by determining whether the frequency of fueling matches the fuel consumption and capacity constraints of the particular vehicle. For example, if a small-sized vehicle, used for local transportation, shows 30 gallons of fuel supply for five consecutive days, the processing unit would flag this data for further investigation. The pattern of abuse for fueling is a series of separate data collections indicating number of units of fuel consumed over time (hours) or distance (mileage) for the same machine indicating fuel consumption outside the authoritative norm published by the manufacturer or government agency. The fuel consumption rates may be positive or negative. The pattern is established from the comparison of the data collections from the machine with the authoritative norm data. The difference is then used to create a predictable mathematical algorithm based upon abnormal or anomaly point found in the consumption data collected. The expected frequency and observed frequency may be compared to determine a pattern of abuse for fueling.

A pattern of abuse may indicate using too much fuel, i.e., fuel theft, machine deterioration (fuel waste due to machine wear, machine manufacture quality control), machine abuse (improper operation), and data collection system abuse (operator abuse of data collection system). It may also mean not using enough fuel, i.e., fueling outside the data collection system, fuel theft, improper machine settings, machine abuse, manufacture quality control, or data collection system abuse.

In a further exemplary embodiment, the processing unit determines whether to perform a function associated with the comparison result based on a pre-defined abuse recognition standard. For example, a standard could be set that directs the processing unit to provide an abuse alert messages if there are three or more irregular data points for a particular vehicle within a set period of time. Furthermore, there could be varying types of alerts or actions taken depending on the frequency of supply data irregularities. All of the foregoing criteria correspond to exemplary consumption criteria used for producing a comparison result.

In some embodiments, the pattern created when frequency of tire air pressure is mal-adjusted over time may be compared to manufacturer's data. This data gathered from an on board data system can be compared to a manufacturer's standard to create a graphical pattern indicating abuse. The pattern of abuse created when tires are improperly inflated compared to manufacturers specifications can be plotted to establish abuse. The pattern of abuse may be quantified and/or determined computationally by collecting tire pressure data over time and measuring rate of decrease in air pressure, comparing it to authoritative norm data, a pattern is established as a predictable mathematical algorithm used to predict the time of tire failure. For systems that automatically keep tires pressurized, the data collection will be focused on air supply and tire pressure cycles. A decrease in time between cycles will be used to predict failure by creating an algorithm that takes the ever increasing time to maintain tire pressure and point to a time when the system will overload and fail. Over and under inflated tires can cause early failure and can be compared to manufacturer's data. Additional plotting of data can predict early failure as compared to same tires maintained properly.

In some embodiments, patterns of abuse can be detected from engine and machine lubricating systems, e.g., those that operate under pressure. If proper levels of lubricant are not maintained, the pressure in the lubrication system will drop. This data gathered from an on board data system, e.g. levels of lubricant or pressure levels, can be compared to manufacturer's standard to create a graphical pattern indicating abuse and detectable and predictable pattern indicating abuse and predicting early failure of the system.

The pattern of abuse may be quantified and/or determined computationally. Lubrication systems monitor pressure and supply of lubricants to machine systems. Monitoring and collecting pressure and supply level data over time will allow the creation of an algorithm (a pattern) that will predict a time to fail by comparing authoritative normal operating pressure and supply data to operating data. In addition the comparative data can be used to indicate abnormal wear in the machine Overfilling of lubrication systems may also indicate and be detected as a pattern of abuse.

In some embodiments, patterns of abuse may be detected in air brake systems. Air brake systems can be abused by applying too much pressure. This data gathered from an on board data system can be compared to manufactures standard to create a graphical pattern indicating abuse. This type of abuse may be detected as a pattern of anomalies that go above the manufactures specifications for applied brake air pressure. This predictable pattern will lead to early failure of the braking system.

Air brake systems fail when either the air supply becomes insufficient, mechanical breakdown or the system is abused. Air brake systems use a compressor to supply air to a reservoir for storage until required for braking. Supply failures can be predicted by tracking storage and use cycles. When the time between storage and use cycles starts to decrease outside normal use applications, an algorithm (pattern) can be created to predict a time to fail by comparing manufacturers' data regarding normal storage and use cycles and comparing it to collected data.

Abuse to an air brake system typically has to do with over application which causes the brakes to overheat and fail. This happens when brakes are applied improperly over time. A failure by abuse could be predicted by measuring length of application in conjunction with speed and load information. By comparing manufacturers data to real road conditions and payload data, an algorithm can be created that will indicate a deteriorating brake system while in application phase. Additionally, the detection of this pattern of abuse may be determined by a computing system. The ability to forecast a brake failure in motor vehicles could be of great value to life, limb and property.

In some embodiments, patterns of abuse in hydraulic brake systems may be determined. Hydraulic brake systems can be abused by applying too much pressure. Data gathered from an on board data system may be compared to manufactures standard to create a graphical pattern indicating abuse. Too much pressure in predictable patterns will indicate an approaching failure, and too little pressure in predictable patterns may also indicate an approaching failure.

In some embodiments, patterns of abuse may be detected in cooling systems. Cooling systems are pressurized and are required to be maintained within a certain range of pressure. Data can be captured and analyzed for anomaly patterns that indicate unanticipated decay of pressure. This data gathered from an on board data system can be compared to manufactures standard to create a graphical pattern indicating abuse or decay due to failure of the containment system.

Cooling systems measure temperature and pressure. It is possible that rate of flow is measured too, but it is not typical. By comparing operating data to authoritative data for normal operations a predictable pattern can be established as a mathematical algorithm based upon the difference in normative and real time operating data. Rising or descending temperature, pressure, and rates of flow outside the normal operating parameters will allow the algorithm to predict a time to fail. Additionally, the detection of this pattern of abuse may be determined by a computing system.

In some embodiments, patterns of abuse may be detected in electrical systems. Electrical systems have need for electrical current that is consumed at an even rate. Deviation from that rate outside manufacturer's standards can cause system failure. Commonly this is seen as a power surge or spike. Over time small fluctuations in electrical power caused by dirt, dust, moisture and corrosion across critical electrical system components will cause minute fluctuations that can be tracked as data. This data gathered from an on board data system may be compared to manufactures standard to create a graphical pattern indicating abusive or degrading power fluctuations that are leading to failure.

By measuring an increasing or decreasing resistance to an electrical circuit over time, an algorithm can be established to predict a fail point. In machines using batteries, the supply and storage cycles will be monitored for increases to supply cycles compared to authoritative norm data to create an algorithm to predict a time when the supply cycle will fail. This data properly analyzed would allow a technician to reconcile the abuse before the system fails. The pattern of abuse may be determined by a computing system.

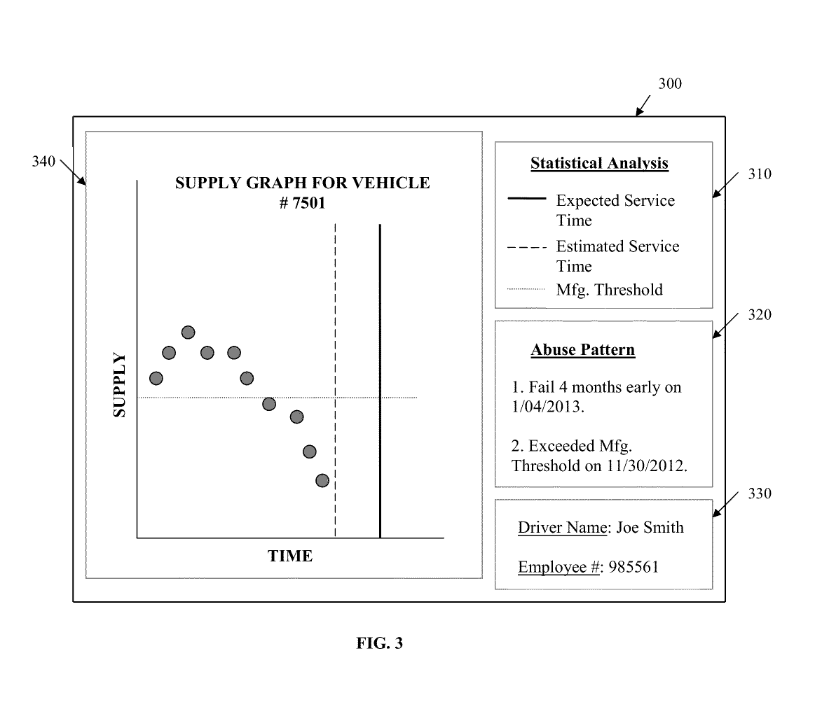

In one further exemplary embodiment, outputting the comparison result is in the form of a graphical user interface displayed through the output port of the computing device. FIG. 3 depicts an exemplary diagram displaying pattern of abuse data produced by the results process module 170 of FIG. 1. The result process module 170 provides a graphical user interface 300 for displaying a statistical analysis interface 310, a abuse pattern data 320, a vehicle identification interface 330 and a pattern of abuse graph 340 for visual inspection of supply data points. The pattern of abuse graph 340 may indicate an expected service time, and estimated service time, and a manufacturer's threshold with respect to a supply data metric.

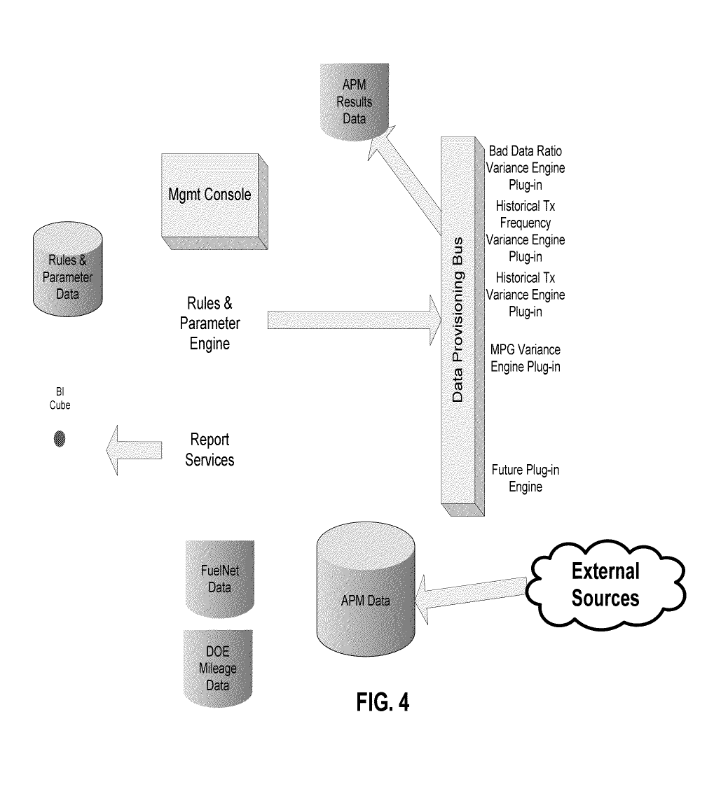

FIG. 4 is a block diagram of an Abuse Pattern Matching (APM) system that utilizes the present invention to detect a pattern of abuse. The system includes a number of databases that store various data/information and parameters for analysis reporting of patterns of abuse. An access card database, such as FuelNet, stores access card related information for billing etc. A FuelNet database stores FuelNet resides in central data repository. Consumption specification data, such as data promulgated by the Department of Energy (DOE), including vehicle mileage data is stored in another public domain database. Results from analysis reside in a central repository and is used for reporting, dashboard, and tuning and configuration. The system of FIG. 4 may use a plug-in architecture that allows for flexibly applying pattern-matching algorithms. A data provisioning bus provides for accurate and fast data analysis. A Rules & Parameter Engine defines constraints of analysis for plug-ins. Reports can be generated for analysis in many formats including XML and CSV.

It will be understood that the above description of the present invention is susceptible to various modifications, changes and adaptations, and that the same are intended to be comprehended within the meaning and range of equivalents of the appended claims.

What is claimed is:

1. A method for detecting a pattern of abuse, the method comprising:
receiving at an input port supply data associated with a corresponding one of said one or more vehicles;
retrieving consumption specification data associated with said one or more vehicles from a storage device, said consumption specification data being specified by at least one of a vehicle manufacturer or an authority;
providing said supply data to a processing unit over a physical transmission medium to determine a pattern of abuse relative to said consumption specification data.

2. The method of claim 1, wherein the pattern of abuse indicates at least one of:
a predicted service time, wherein the predicted service time is earlier than an expected service time indicated by the consumption specification data; and
an abuse pattern model.

3. The method of claim 1, further comprising comparing said pattern of abuse to a consumption criterion to produce a comparison result.

4. The method of claim 3, further comprising outputting data associated with said comparison result wherein outputting comprises displaying said comparison result or placing said comparison result on another physical transmission medium for further processing, or performing a function associated with said comparison result.

5. The method of claim 3, wherein said function comprising communicating an alert message.

6. The method of claim 1, wherein the pattern of abuse indicates abuse in at least one of a tire, a lubrication system, an air brake system, a hydraulic braking system, a cooling system, and an electrical system.

7. A system for detecting a pattern of abuse, the system comprising:
an input port for receiving supply data associated with a corresponding one of said one or more vehicles;
a storage device for storing consumption specification data associated with said one or more vehicles, said consumption specification data being specified by at least one of vehicle manufacturer or an authority;
a processing unit for processing said supply data to determine a pattern of abuse relative to said consumption specification data.

8. The system of claim 7, wherein the pattern of abuse indicates at least one of:
a predicted service time, wherein the predicted service time is earlier than an expected service time indicated by the consumption specification data; and
an abuse pattern model.

9. The system of claim 7, further comprising a comparator logic that compares said pattern of abuse to a consumption criterion to produce a comparison result.

10. The system of claim 9, further comprising an output port that outputs data associated with said comparison result wherein said port is coupled to a display unit for displaying said comparison result or to another physical transmission medium for further processing the pattern of abuse or comparison result.

11. The system of claim 9, wherein said function comprises communicating an alert message.

12. The method of claim 7, wherein the pattern of abuse indicates abuse in at least one of a tire, a lubrication system, an air brake system, a hydraulic braking system, a cooling system, and an electrical system.
